(19) United States
(12) Patent Application Publication
(10) Pub. No.: US 2025/0145044 A1
(43) Pub. Date: May 8, 2025

(54) NONCONTACT POWER SUPPLY SYSTEM, SERVER, AND NONCONTACT POWER SUPPLY METHOD

(71) Applicants: TOYOTA JIDOSHA KABUSHIKI KAISHA, Toyota-shi, Aichi (JP); DENSO CORPORATION, Kariya-shi, Aichi (JP)

(72) Inventors: Kazutaka KIMURA, Mishima-shi (JP); Toshiya HASHIMOTO, Miyoshi-shi (JP); Makoto HASHIMOTO, Seto-shi (JP); Masaki KANESAKI, Susono-shi (JP); Keisuke TANI, Kariya-shi (JP); Nobuhisa YAMAGUCHI, Kariya-shi (JP); Kazuyoshi OBAYASHI, Kariya-shi (JP); Yuichi TAKEMURA, Kariya-shi (JP)

(73) Assignees: TOYOTA JIDOSHA KABUSHIKI KAISHA, Toyota-shi, Aichi (JP); DENSO CORPORATION, Kariya-shi, Aichi (JP)

(21) Appl. No.: 18/726,238

(22) PCT Filed: Feb. 24, 2023
(86) PCT No.: PCT/JP2023/006848

§ 371 Date: Jul. 2, 2024

(30) Foreign Application Priority Data
Mar. 7, 2022 (JP) 2022-034839

(51) Int. Cl. B60L 53/66; B60L 53/126; B60L 53/68

(52) U.S. Cl. CPC B60L 53/665; B60L 53/126; B60L 53/68

(57) ABSTRACT

A noncontact power supply system is provided with a mobile unit, a ground power supply apparatus configured to be able to supply power by noncontact to the mobile unit and a server configured to be able to communicate with the mobile unit and the ground power supply apparatus respectively. The server is configured to set a system utilization price of the noncontact power supply system based on the demand for power and, when an intent by the mobile unit for utilization of the noncontact power supply system at the system utilization price is confirmed, enable the mobile unit with a confirmed intent for utilization to be supplied with power by noncontact by sending information necessary for noncontact power supply to the mobile unit with a confirmed intent for utilization and ground power supply apparatus.

### FIELD

The present invention relates to a noncontact power supply system, server, and noncontact power supply method.

### BACKGROUND

The present invention relates to a ground power supply apparatus, a noncontact power supply system, a method of control of a ground power supply apparatus, and a computer program.

### SUMMARY

To stably supply electric power to the market, it is necessary to suitably maintain the balance of supply and demand of power. If the supply of power is insufficient relative to the demand for power or if insufficiency is expected, if ending up using noncontact power supply to supply power to all vehicles desiring noncontact power supply, it is liable to become difficult to suitably maintain the supply and demand balance. For this reason, in such a case, it is necessary to enable mobile units with a high need for supply of power to be able to be suitably supplied with power by noncontact.

The present invention was made focusing on such a problem and has as its object to enable mobile units with a high need for supply of electric power to be able to be suitably supplied by noncontact with power while suitably maintaining the supply and demand balance of power.

To solve the above problem, a noncontact power supply system of one aspect of the present invention is provided with a mobile unit, a ground power supply apparatus configured to be able to supply power by noncontact to the mobile unit, and a server configured to be able to communicate with the mobile unit and ground power supply apparatus. Further, the server is configured so as to set a system utilization price of the noncontact power supply system based on the power demand and, when an intent by the mobile unit for utilization of the noncontact power supply system at the system utilization price is confirmed, to enable the mobile unit with a confirmed intent for utilization to be supplied with power by noncontact by sending information necessary for noncontact power supply to the mobile unit with a confirmed intent for utilization and ground power supply apparatus.

Further, a server according to another aspect of the present invention is comprised of a processing part and a communication part configured so as to communicate with a mobile unit and a ground power supply apparatus configured to be able to supply electric power by noncontact to the mobile unit. Further, the processing part is configured to set a system utilization price of the noncontact power supply system supplying power by noncontact to the mobile unit based on demand for power and, when an intent by the mobile unit for utilization of the noncontact power supply system at the system utilization price is confirmed, enable the mobile unit with a confirmed intent for utilization to be supplied with power by noncontact by sending information necessary for noncontact power supply to the mobile unit with a confirmed intent for utilization and ground power supply apparatus.

Further, a method of noncontact power supply according to still another aspect of the present invention is a method of noncontact power supply of a noncontact power supply system performed by a server able to communicate with a mobile unit and a ground power supply apparatus configured to be able to supply electric power by noncontact to the mobile unit, the method of noncontact power supply setting a system utilization price of the noncontact power supply system based on demand for power, confirming an intent by the mobile unit for utilization of the noncontact power supply system at the system utilization price, and, when intent for utilization is confirmed, enable the mobile unit with a confirmed intent for utilization to be supplied with power by noncontact by sending information necessary for noncontact power supply to the mobile unit with a confirmed intent for utilization and ground power supply apparatus.

According to these aspects of the present invention, mobile units with a confirmed intent of utilization at the system utilization price determined based on the demand for power can be supplied with power by noncontact power supply. It is envisioned that as the system utilization price becomes higher, mobile units with a low need for power supply will no longer desire noncontact power supply. For this reason, by setting a suitable system utilization price in accordance with the demand for power, it is possible to suitably supply power by noncontact to mobile units with a high need for supply of power while suitably maintaining the balance of supply and demand of power.

### BRIEF DESCRIPTION OF THE DRAWINGS

FIG. 1 is a schematic view of the configuration of a noncontact power supply system.

FIG. 2 is a view showing one example of the configurations of a ground power supply apparatus and vehicle.

FIG. 3 is a schematic view of the configurations of a power transmission controller and equipment connected to the power transmission controller.

FIG. 4 is a schematic view of the configurations of a vehicle controller and equipment connected to the vehicle controller.

FIG. 5 is an operation sequence diagram explaining a method of supplying power by noncontact power supply according to a first embodiment of the present invention.

FIG. 6 is an operation sequence diagram explaining a method of supplying power by noncontact power supply according to a second embodiment of the present invention.

FIG. 7 is a view showing one example of the configuration of a ground power supply apparatus.

### DESCRIPTION OF EMBODIMENTS

Below, embodiments will be explained in detail while referring to the drawings. Note that, in the following explanation, similar component elements will be assigned the same reference notations.

### First Embodiment

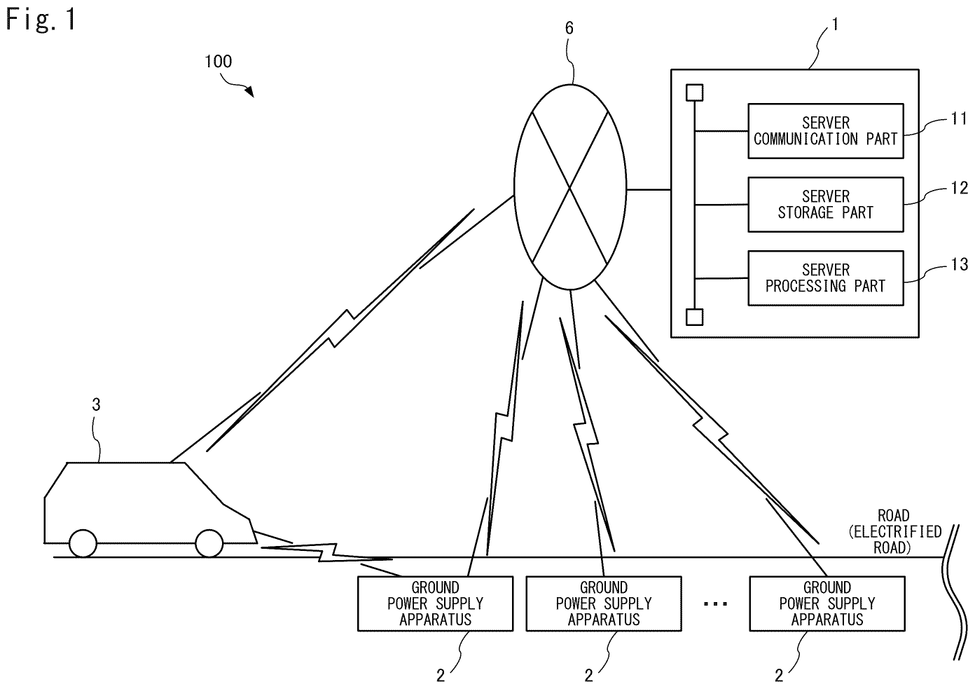

FIG. 1 is a schematic view of the configuration of a noncontact power supply system 100 according to a first embodiment of the present invention.

The noncontact power supply system 100 is provided with a server 1, a ground power supply apparatus 2, and a vehicle 3 as one example of a mobile unit and is configured to be able to supply a running or stopped vehicle 3 obtaining permission of system use with power from the ground power supply apparatus 2 by noncontact using magnetic field resonant coupling (magnetic field resonance). Note that, in FIG. 1, as one example of installation of the ground power supply apparatus 2, the example is shown where ground power supply apparatuses 2 are installed consecutively along the road at predetermined intervals. In the following explanation, a road at which ground power supply apparatuses 2 are installed will be referred to as an “electrified road” in accordance with need.

Note that, in this Description, the term “run” means the state where the vehicle 3 is positioned on the road for running. Therefore, the term “run” includes not only the state where the vehicle 3 is actually running by any speed larger than zero, but also the state where for example it is stopped on the road waiting for a traffic light to change etc.

As shown in FIG. 1, the server 1 is provided with a server communication part 11, server storage part 12, and server processing part 13.

The server communication part 11 has a communication interface circuit for connecting the server 1 to a network 6 and is configured to enable the ground power supply apparatus 2 and the vehicle 3 to communicate through the network 6.

The server storage part 12 has an HDD (hard disk drive) or SSD (solid state drive), optical recording medium, semiconductor memory, or other storage medium and stores various computer programs, data, etc. used for processing at the server processing part 13.

The server processing part 13 has one or more CPUs (central processing units) and their peripheral circuits. The server processing part 13 runs the various computer programs stored in the server storage part 12 and exerts comprehensive control over the overall operations of the server 1. It is, for example, a processor.

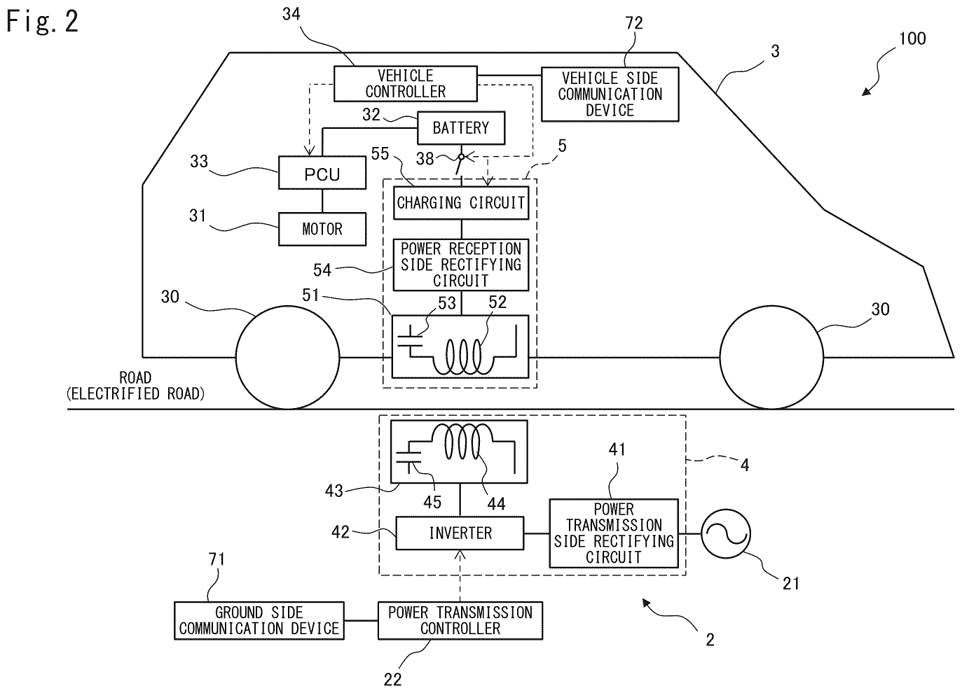

Next, referring to FIG. 2 to FIG. 4, the configurations of the ground power supply apparatus 2 and vehicle 3 according to the present embodiment will be explained. FIG. 2 is a view showing one example of the configurations of the ground power supply apparatus 2 and vehicle 3 according to the present embodiment.

As shown in FIG. 2, the ground power supply apparatus 2 has a ground side communication device 71, power transmission device 4, power source 21, and power transmission controller 22. The ground side communication device 71, power source 21, and power transmission controller 22 may be buried in the road or may be placed at a location other than the road (including on the ground).

The ground side communication device 71 is configured to be able to communicate with the server 1 and the vehicle 3.

In the present embodiment, the ground side communication device 71 is configured to access a wireless base station connected through the network 6, a gateway, etc. to thereby enable connection with the network 6 through the wireless base station. Due to this, wide area wireless communication is performed between the ground side communication device 71 and the server 1. For example, various information required for supplying power to the vehicle 3 by noncontact is swapped. Wide area wireless communication is communication with a longer communication distance compared with the later explained narrow area wireless communication. Specifically, for example, it is communication with a communication distance of from 10 meters to 10 kilometers. As wide area wireless communication, various wireless communication standards with long communication distances can be used. For example, communication based on any communication standards such as 4G, LTE, 5G, WiMAX, etc. formulated by the 3GPP and IEEE is used.

Further, in the present embodiment, the ground side communication device 71 is configured to be able to utilize a predetermined wireless communication channel to engage in narrow area wireless communication directly with a vehicle side communication device 72 mounted in the vehicle 3. Narrow area wireless communication is communication with a shorter communication distance compared with wide area wireless communication. Specifically, for example, it is communication with a communication distance of less than 10 meters. As narrow area wireless communication, various near field communication standards with short communication distances can be used. For example, communication based on any communication standards (for example, Bluetooth (Registered Trademark) or ZigBee (Registered Trademark)) formulated by the IEEE, ISO, IEC, etc. is used. Further, as technology for narrow area wireless communication, for example, RFID (radio frequency identification), DSRC (dedicated short range communication), etc. are used.

The power source 21 supplies power to the power transmission device 4. The power source 21 is, for example, a commercial AC power source supplying single-phase AC power. Note that, the power source 21 may also be another AC power source supplying three-phase AC power or may be a DC power source such as a fuel cell.

The power transmission device 4 transmits the power supplied from the power source 21 to the vehicle 3. The power transmission device 4 has a power transmission side rectifying circuit 41, inverter 42, and power transmission side resonance circuit 43. In the power transmission device 4, the AC power supplied from the power source 21 is rectified at the power transmission side rectifying circuit 41 and converted to DC current, the DC current is converted to AC current at the inverter 42, and that AC power is supplied to the power transmission side resonance circuit 43.

The power transmission side rectifying circuit 41 is electrically connected to the power source 21 and inverter 42. The power transmission side rectifying circuit 41 rectifies the AC power supplied from the power source 21 to convert it to DC power and supplies the DC power to the inverter 42. The power transmission side rectifying circuit 41 is for example an AC/DC converter.

The inverter 42 is electrically connected to the power transmission side rectifying circuit 41 and power transmission side resonance circuit 43. The inverter 42 converts the DC power supplied from the power transmission side rectifying circuit 41 to AC power of a frequency higher than the AC power of the power source 21 (high frequency power) and supplies the high frequency power to the power transmission side resonance circuit 43.

The power transmission side resonance circuit 43 has a resonator comprised of a coil 44 and capacitor 45. The various parameters of the coil 44 and capacitor 45 (outside diameter and inside diameter of coil 44, number of turns of coil 44, electrostatic capacity of capacitor 45, etc.) are determined so that the resonance frequency of the power transmission side resonance circuit 43 becomes a set value. The predetermined set value is, for example, 10 kHz to 100 GHz, preferably is the 85 kHz determined by the SAE TIR J2954 standard as the frequency band for noncontact power transmission.

The power transmission side resonance circuit 43 is arranged at the center of a lane in which the vehicle 3 passes so that the center of the coil 44 is positioned at the center of the lane. If the high frequency power supplied from the inverter 42 is applied to the power transmission side resonance circuit 43, the power transmission side resonance circuit 43 generates an AC magnetic field for power transmission. Note that, if the power source 21 is a DC power source, the power transmission side rectifying circuit 41 may be omitted.

The power transmission controller 22 performs various control over the ground power supply apparatus 2. For example, the power transmission controller 22 is electrically connected to the inverter 42 of the power transmission device 4 and controls the inverter 42 so as to control the power transmission by the power transmission device 4. Further, the power transmission controller 22 communicates with the server 1 and the vehicle 3 through the ground side communication device 71. Note that the vehicle 3 can be directly communicate with through the ground side communication device 71 and can be indirectly communicated with from the ground side communication device 71 through the server 1.

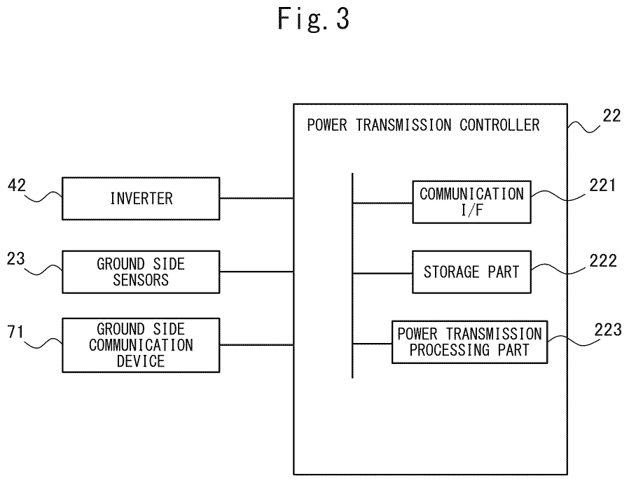

FIG. 3 is a schematic view of the configurations of the power transmission controller 22 and equipment connected to the power transmission controller 22.

The power transmission controller 22 is provided with a communication interface 221, storage part 222, and power transmission processing part 223. The communication interface 221, storage part 222, and power transmission processing part 223 are connected with each other through signal wires.

The communication interface 221 has an interface circuit for connecting the power transmission controller 22 to the various equipment forming the ground power supply apparatus 2 (for example, inverter 42, ground side communication device 71, later explained ground side sensors 23, etc.) The power transmission controller 22 communicates with the various equipment forming the ground power supply apparatus 2 through the communication interface 221.

The storage part 222 has an HDD or SSD, optical recording medium, semiconductor memory, or other storage medium and stores various computer programs, data, etc. used for processing at the power transmission processing part 223.

The power transmission processing part 223 has one or more CPUs (central processing units) and their peripheral circuits. The power transmission processing part 223 runs the various computer programs stored in the storage part 222 and exerts comprehensive control over the overall operations of the ground power supply apparatus 2. It is, for example, a processor.

The power transmission controller 22 has ground side sensors 23 connected to it. The ground side sensors 23, for example, include a power transmission device current sensor for detecting the current flowing through the various parts of the power transmission device 4 (in particular, the power transmission side resonance circuit 43, inverter 42, and power transmission side rectifying circuit 41), a power transmission device voltage sensor for detecting the voltage applied to the various parts of the power transmission device 4, a power transmission device temperature sensor for detecting the temperature of the various parts of the power transmission device 4, a foreign object sensor for detecting a foreign object on the road in which the power transmission device 4 is buried, and a bio sensor for detecting a person or animal on the road at which the power transmission device 4 is buried. The outputs of the ground side sensors 23 are input to the power transmission controller 22.

Returning to FIG. 2, the vehicle 3 has a vehicle side communication device 72, power reception device 5, motor 31, battery 32, power control unit (PCU) 33, and vehicle controller 34. The vehicle 3 according to the present embodiment is a battery electric vehicle (BEV) having only the battery 32 as its source of drive power, but may also be a so-called hybrid vehicle provided with an internal combustion engine or other drive source in addition to the battery 32 (HEV; hybrid electric vehicle or PHEV; plug-in hybrid electric vehicle). The type is not particularly limited.

The vehicle side communication device 72 is configured to be able to communicate with the server 1 and ground power supply apparatus 2. In the present embodiment, the vehicle side communication device 72 is configured to be able to access a wireless base station connected with the network 6 through a gateway etc. and thereby connect with the network 6 through the wireless base station. Due to this, wide area wireless communication is performed between the vehicle side communication device 72 and server 1.

Further, the vehicle side communication device 72 is configured to be able to utilize a predetermined wireless communication channel to directly engage in narrow area wireless communication with the ground side communication device 71 of the ground power supply apparatus 2.

The motor 31 is, for example, an AC synchronous motor and functions as an electric motor and a generator. When functioning as an electric motor, the motor 31 is driven by the power stored in the battery 32 as the drive source. The output of the motor 31 is transmitted through a speed reducer and axle to the wheels 30. On the other hand, when the vehicle 3 is decelerating, the motor 31 is driven by rotation of the wheels 30 whereby the motor 31 functions as a generator to generate regenerative power.

The battery 32 is a rechargeable secondary battery and is, for example, comprised of a lithium ion battery, nickel hydrogen battery, etc. The battery 32 stores the power required for the vehicle 3 to run (for example, drive power of the motor 31). The battery 32 is charged if the power received by the power reception device 5 is supplied to the battery 32. Further, the battery 32 is charged if the regenerative power generated by the motor 31 is supplied to the battery 32. If the battery 32 is charged, the state of charge (SOC) of the battery 32 is restored. Note that, the battery 32 may also be charged by an outside power source other than the ground power supply apparatus 2 through a charging port provided at the vehicle 3.

The PCU 33 is electrically connected to the battery 32 and motor 31. The PCU 33 has an inverter, boost converter, and DC/DC converter. The inverter converts the DC power supplied from the battery 32 to AC power and supplies the AC power to the motor 31. On the other hand, the inverter converts the AC power generated by the motor 31 (regenerative power) to DC power and supplies the DC power to the battery 32. When the power stored in the battery 32 is supplied to the motor 31, the boost converter boosts the voltage of the battery 32 in accordance with need. The DC/DC converter lowers the voltage of the battery 32 when the power stored in the battery 32 is supplied to headlights or other electronic equipment.

The power reception device 5 supplies power received from the power transmission device 4 to the battery 32. The power reception device 5 has a power reception side resonance circuit 51, power reception side rectifying circuit 54, and charging circuit 55.

The power reception side resonance circuit 51 is arranged at the bottom part of the vehicle 3 so that the distance from the road surface becomes smaller. The power reception side resonance circuit 51 has a configuration similar to the power transmission side resonance circuit 43 and has a resonator comprised of a coil 52 and capacitor 53. The various parameters of the coil 52 and capacitor 53 (outside diameter and inside diameter of the coil 52, number of turns of the coil 52, electrostatic capacity of the capacitor 53, etc.) are determined so that the resonance frequency of the power reception side resonance circuit 51 matches with the resonance frequency of the power transmission side resonance circuit 43. Note that, if the amount of deviation of the resonance frequency of the power reception side resonance circuit 51 and the resonance frequency of the power transmission side resonance circuit 43 is small, for example, if the resonance frequency of the power reception side resonance circuit 51 is within a range of ±20% of the resonance frequency of the power transmission side resonance circuit 43, the resonance frequency of the power reception side resonance circuit 51 does not necessarily have to match the resonance frequency of the power transmission side resonance circuit 43.

When the power reception side resonance circuit 51 is facing the power transmission side resonance circuit 43 and an AC magnetic field is generated by the power transmission side resonance circuit 43, the vibration of the AC magnetic field is transmitted to the power reception side resonance circuit 51 resonating by the same resonance frequency as the power transmission side resonance circuit 43. As a result, an induced current flows to the power reception side resonance circuit 51 by electromagnetic induction and an induced electromotive force is generated at the power reception side resonance circuit 51 by the induced current. That is, the power transmission side resonance circuit 43 transmits power to the power reception side resonance circuit 51, while the power reception side resonance circuit 51 receives power from the power transmission side resonance circuit 43.

The power reception side rectifying circuit 54 is electrically connected to the power reception side resonance circuit 51 and charging circuit 55. The power reception side rectifying circuit 54 rectifies the AC power supplied from the power reception side resonance circuit 51, converts it to DC power, and supplies the DC power to the charging circuit 55. The power reception side rectifying circuit 54 is, for example, an AC/DC converter.

The charging circuit 55 is electrically connected to the power reception side rectifying circuit 54 and battery 32. In particular, it is connected to the battery 32 through a relay 38. The charging circuit 55 convert the DC power supplied from the power reception side rectifying circuit 54 to the voltage level of the battery 32 and supplies it to the battery 32. The battery 32 is charged if the power transmitted from the power transmission device 4 is supplied by the power reception device 5 to the battery 32. The charging circuit 55 is, for example, a DC/DC converter.

The vehicle controller 34 performs various control over the vehicle 3. For example, the vehicle controller 34 is electrically connected to the charging circuit 55 of the power reception device 5 and controls the charging circuit 55 to control the charging of the battery 32 by the power transmitted from the power transmission device 4. Further, the vehicle controller 34 is electrically connected to the PCU 33 and controls the PCU 33 to control the transfer of power between the battery 32 and the motor 31. Furthermore, the vehicle controller 34 controls the vehicle side communication device 72.

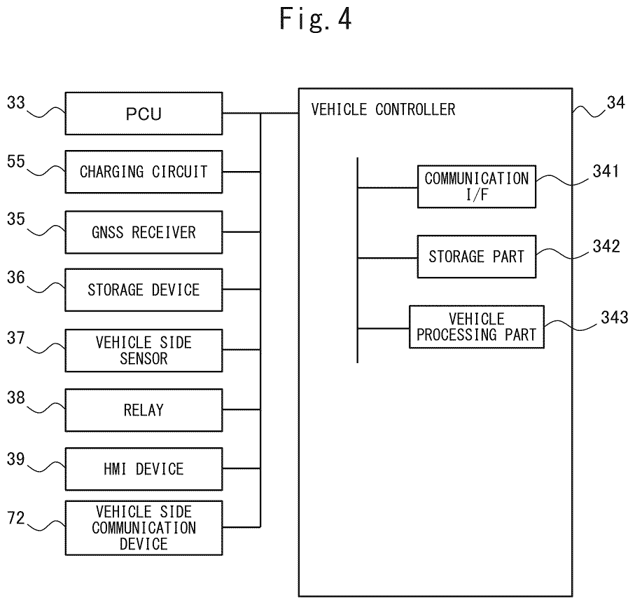

FIG. 4 is a schematic view of the configuration of the vehicle controller 34 and equipment connected to the vehicle controller 34.

The vehicle controller 34 has a communication interface 341, storage part 342, and vehicle processing part 343. The communication interface 341, storage part 342, and vehicle processing part 343 are connected with each other through signal wires.

The communication interface 341 has an interface circuit for connecting the vehicle controller 34 to an internal network based on the CAN or the standard. The vehicle controller 34 communicates with other equipment through the communication interface 341.

The storage part 342 has an HDD or SSD, optical recording medium, semiconductor memory, or other storage medium and stores the various computer programs, data, etc. used for processing at the vehicle processing part 343.

The vehicle processing part 343 has one or more CPUs (central processing units) and their peripheral circuits. The vehicle processing part 343 runs the various computer programs stored in the storage part 342 and exerts comprehensive control over the overall operations of the vehicle 3. It is, for example, a processor.

Further, the vehicle 3 is further provided with a GNSS receiver 35, storage device 36, a plurality of vehicle side sensors 37, the relay 38, and an HMI device 39. The GNSS receiver 35, storage device 36, vehicle side sensors 37, relay 38, and HMI device 39 are electrically connected to the vehicle controller 34 through the internal network.

The GNSS receiver 35 detects the current position of the vehicle 3 (for example, the latitude and longitude of the vehicle 3) based on positioning information obtained from a plurality of (for example, three or more) positioning satellites. The output of the GNSS receiver 35, that is, the current position of the vehicle 3 detected by the GNSS receiver 35, is transmitted to the vehicle controller 34.

The storage device 36 stores data. The storage device 36 is, for example, provided with an HDD, SSD (solid state drive), or optical recording medium. In the present embodiment, the storage device 36 stores map information. The map information includes, in addition to information relating to roads, information on installation positions of the ground power supply apparatuses 2 and other information. The vehicle controller 34 acquires map information from the storage device 36. Note that, the storage device 36 need not contain map information. In that case, the vehicle controller 34 may acquire map information from outside the vehicle 3 (for example, the server 1) through the vehicle side communication device 72.

The vehicle side sensors 37 detect the state of the vehicle 3. In the present embodiment, the vehicle side sensors 37 include, as sensors for detecting the state of the vehicle 3, a speed sensor for detecting the speed of the vehicle 3, a battery temperature sensor for detecting the temperature of the battery 32, a power reception device temperature sensor for detecting the temperature of the various parts of the power reception device 5 (in particular, the power reception side resonance circuit 51 and power reception side rectifying circuit 54), a battery current sensor for detecting a charging current value and discharging current value of the battery 32, a power reception device current sensor for detecting the current flowing to the various parts of the power reception device 5, and a power reception device voltage sensor for detecting the voltage applied to the various parts of the power reception device 5. The outputs of the vehicle side sensors 37 are input to the vehicle controller 34.

The relay 38 is arranged between the battery 32 and the power reception device 5 and connects and disconnects the battery 32 and the power reception device 5. When the relay 38 is connected, the power which the power reception device 5 receives is supplied to the battery 32. However, when the relay 38 is disconnected, current does not flow from the power reception device 5 to the battery 32 and accordingly the power reception device 5 can substantially no long receive power.

The HMI device 39 is an interface for transferring information with occupants of the vehicle. The HMI device 39 according to the present embodiment is provided with a display and speaker for providing the vehicle occupants with various types of information and a touch panel (or operating buttons) for the vehicle occupants to enter information. The HMI device 39 transmits input information entered by the vehicle occupants through the internal network to various devices requiring that input information (for example, the vehicle controller 34) and provides the vehicle occupants with the information received through the internal network by showing it on the display etc.

In this regard, to stably supply electric power to the market, it is necessary to suitably maintain the balance of supply and demand of power. If the supply of power is insufficient relative to the demand for power or if insufficiency is expected, if ending up using noncontact power supply to supply power to all vehicles 3 desiring noncontact power supply, it is liable to become difficult to suitably maintain the supply and demand balance. For this reason, in such a case, it is necessary to enable vehicles 3 with a high need for supply of power to be able to be suitably supplied with power by noncontact.

Therefore, in the present embodiment, to enable vehicles 3 with a high need for supply of power to be able to be suitably supplied with power by noncontact while suitably maintaining the balance of supply and demand of power, it is possible to set a price for utilization of the noncontact power supply system 100 based on the demand for power (below, referred to as the “system utilization price”) and to supply power by noncontact to vehicles 3 with a confirmed intent for utilization at the system utilization price.

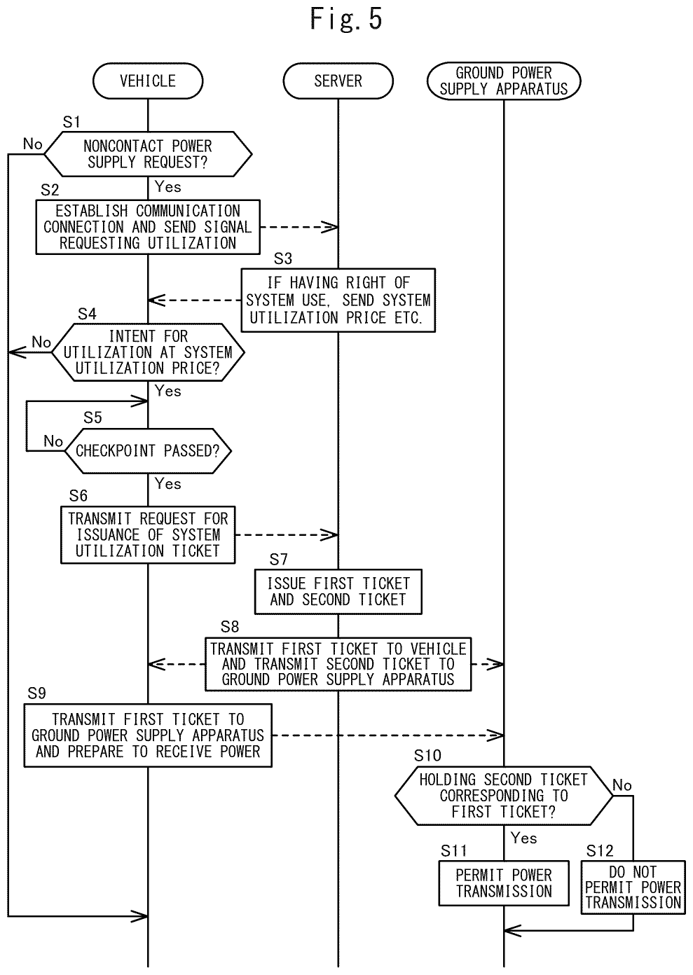

FIG. 5 is an operation sequence diagram explaining a method of supplying power by noncontact power supply according to the present embodiment.

At step S1, the vehicle controller 34 judges whether the vehicle 3 in which that vehicle controller 34 is mounted (host vehicle) is requesting noncontact power supply. If the host vehicle 3 is requesting noncontact power supply, the vehicle controller 34 proceeds to the processing of step S2. On the other hand, if the host vehicle 3 is not requesting noncontact power supply, the processing vehicle controller 34 ends the processing. In the present embodiment, the vehicle occupants are made able to manually switch between requesting noncontact power supply or not through the HMI device 39, but the invention is not limited to this. For example, it also possible to automatically switch between requesting noncontact power supply or not in accordance with the state of charge of the battery 32.

At step S2, the vehicle controller 34, for example, performs a three-way handshake to establish communication connection with the server 1, then transmits to the server 1 a signal requesting utilization of the noncontact power supply system 100. This signal requesting utilization includes, for example, various information required for utilizing the noncontact power supply system 100 (for example authentication information etc.)

At step S3, the server 1 confirms whether the vehicle 3 with a communication connection established at step S2 (connected vehicle) has the right to utilize the noncontact power supply system 100. The vehicle 3 for which confirmation has been obtained is sent the current system utilization price determined based on the demand for power and an encryption key for decrypting a later explained encrypted system utilization ticket.

In the present embodiment, the server 1 judges the demand for power based on the number of the vehicles 3 for which a communication connection has been established, that is, the number of vehicles 3 requesting noncontact power supply, and raises the system utilization price the greater the demand for power. The demand for power is naturally judged larger the greater the number of vehicles 3 requesting noncontact power supply. Regarding the demand for power, for example, it is also possible to consider demand for power for air-conditioning at homes etc. and other demand for power other than the noncontact power supply and to consider factors other than the number of vehicles 3 requesting noncontact power supply such as the outside air temperature and judge the size of the same. Further, in the present embodiment, the system utilization price is made the price per 1 kWh of the consumption of electric power (yen/kWh), but the invention is not limited to this.

At step S4, the vehicle controller 34 proposes the received current system utilization price to the vehicle occupants through the HMI device 39 and confirms if there is the intent to utilize the noncontact power supply system 100 at the proposed system utilization price (intent to receive noncontact power supply). As a result, if the vehicle occupants respond to the effect of there being the intent to utilize the noncontact power supply system 100 at the proposed system utilization price, the vehicle controller 34 proceeds to the processing of step S5. On the other hand, if the vehicle occupants respond to the effect of there not being the intent to utilize the noncontact power supply system 100 at the proposed system utilization price or if no response is obtained even after a predetermined time period has elapsed from when proposing the system utilization price, the vehicle controller 34 ends the current processing.

At step S5, the vehicle controller 34 judges if a checkpoint set at a location before the electrified road section has been passed. If a checkpoint has been passed, the vehicle controller 34 proceeds to the processing of step S6. On the other hand, if a checkpoint has not been passed, the vehicle controller 34 again judges if a checkpoint has been passed after the elapse of a predetermined time period.

Regarding whether or not a checkpoint has been passed, if a gate is set at for example the checkpoint, it can be judged if the checkpoint has been passed by the vehicle controller 34 receiving a signal generated from the gate. At this time, the vehicle controller 34 can receive information relating to the checkpoint, such as position information of the checkpoint, from the gate. Further, for example, if information relating to the checkpoint is included in map information in the storage device 36 or if information relating to the checkpoint is received from storage server 1, it is possible to judge that the checkpoint has been passed based on the position information of the host vehicle 3 and the position information of the checkpoint. In this way, the method of judging whether a checkpoint has been passed is not particularly limited.

Note that, in the present embodiment, at this step S5, whether the checkpoint has been passed is judged, but the invention is not limited to this. For example, whether the checkpoint has been approached may also be judged.

Whether the checkpoint has been approached can, for example, by judged by the vehicle controller 34 receiving a signal generated from an apparatus transmitting a signal to a vehicle 3 positioned within a certain fixed range based on the checkpoint if such an apparatus is installed at the checkpoint. The invention is not limited to this. This can also be judged based on the position information of the host vehicle 3 and the position information of the checkpoint. The certain fixed range based on the checkpoint can, for example, be made a partial road section before entering an electrified road section if a road section of a predetermined range where a signal change is awaited so as to enable a vehicle awaiting a signal change to be supplied with power by noncontact is an electrified road section.

At step S6, the vehicle controller 34 transmits to the server 1 a request for issuance of a system utilization ticket comprised of a virtual ticket for utilization of the noncontact power supply system 100 together with identification information of the host vehicle and information relating to the passed checkpoint.

At step S7, if receiving a request for issuance of a system utilization ticket, the server 1 judges whether the identified vehicle 3 originating the request for issuance has the intent for utilization of the noncontact power supply system 100 at the system utilization price, identifies the vehicle 3 originating the request for issuance based on the identification information, and issues a first ticket comprised of a system utilization ticket for transmission to the identified vehicle 3 originating the request for issuance and a unique system utilization ticket prepared for each vehicle 3 having the right to utilize the noncontact power supply system 100. Further, the server 1 issues a second ticket comprised of a system utilization ticket corresponding to the first ticket and a system utilization ticket for transmission to the ground power supply apparatus 2.

Note that, the present embodiment uses the reception of a request for issuance of a system utilization ticket to judge that the vehicle 3 originating the request for issuance has the intent for utilization at the system utilization price, but the invention is not limited to this. If there is an intent for utilization at the system utilization price, a notification to that effect is transmitted from the vehicle to the server 1 and reception of that notification is used to judge that there is intent for utilization.

At step S8, the server 1 transmits an encrypted first ticket to the vehicle 3 originating the request for issuance of the system utilization ticket and transmits the second ticket to each ground power supply apparatus 2 linked with the checkpoint. A “ground power supply apparatus 2 linked with the checkpoint” is a ground power supply apparatus 2 installed in an electrified road section which a vehicle 3 passing the checkpoint may run on. The server storage part 12 of the server 1 according to the present embodiment stores in advance the ground power supply apparatuses 2 linked with a checkpoint for each checkpoint.

At step S9, the vehicle controller 34 decrypts the received first ticket using the encryption key and controls the power reception device 5 so as to start periodic and direct transmission of the decrypted first ticket to the ground power supply apparatus 2 through the vehicle side communication device 72 by narrow area wireless communication and be able to receive power when the host vehicle 3 is running on or stopped at the ground power supply apparatus 2.

At step S10, if receiving the first ticket by greater than or equal to a predetermined communication strength (strength of received signal), the ground power supply apparatus 2 judges whether it has already received a second ticket corresponding to the received first ticket from the server 1, that is, whether it holds a second ticket corresponding to the received first ticket. If holding a second ticket corresponding to the first ticket, the ground power supply apparatus 2 proceeds to the processing of step S11. On the other hand, if not holding a second ticket corresponding to the first ticket, the ground power supply apparatus 2 proceeds to the processing of step S12.

At step S11, the ground power supply apparatus 2 judges that the vehicle 3 which will run on or stop at the apparatus is a permitted vehicle obtaining permission of use and controls the power transmission device 4 so as to transmit power to the vehicle 3 when it is running on or stopped at the apparatus.

At step S12, the ground power supply apparatus 2 judges that the vehicle 3 which will run on or stop at the apparatus is a nonpermitted vehicle for which permission of system use has not been obtained and controls the power transmission device 4 so as not to transmit electric power to the vehicle 3 when it is running on or stopped at the apparatus.

Note that, various variations may be considered for up to when system utilization at the system utilization price proposed to the vehicle 3 at step S3 is permitted, in other words, at what point of time to newly confirm the intent for system utilization at the system utilization price newly set based on the demand for power. For example, simplified, it is possible to newly confirm the intent for system utilization if the elapsed time or running distance from when permitting system utilization, the amount of power supply, etc. exceed fixed values.

Further, if, like in the present embodiment, it is possible to confirm the passage or approach to a checkpoint by a vehicle 3 at the server side, each time confirming the passage or approach to a checkpoint by a vehicle 3, it is also possible to confirm the intent for system utilization from the next checkpoint and propose a newly set system utilization price to the vehicle 3.

The noncontact power supply system 100 according to the present embodiment explained above is provided with a vehicle 3 (mobile unit), a ground power supply apparatus 2 configured to be able to supply power by noncontact to the vehicle 3, and a server 1 configured to be able to communicate with the vehicle 3 and the ground power supply apparatus 2 respectively. Further, the server 1 according to the present embodiment is further configured so as to set a system utilization price of the noncontact power supply system 100 based on the demand for power and, when an intent by the vehicle 3 for utilization of the noncontact power supply system 100 at the system utilization price is confirmed, to enable the vehicle 3 with a confirmed intent for utilization to be supplied with power by noncontact by sending the information necessary for noncontact power supply to the vehicle 3 with a confirmed intent for utilization and ground power supply apparatus 2.

Specifically, the server 1 according to the present embodiment is configured to notify the system utilization price to the vehicle 3 and receive a reply based on the notification from the vehicle 3 to thereby confirm the intent of utilization of the noncontact power supply system at the system utilization price by the vehicle 3. The reply based on the notification is a request for issuance of a system utilization ticket (virtual ticket) for utilization of the noncontact power supply system 100.

Due to this, a vehicle 3 with a confirmed intent for utilization at the system utilization price determined based on the demand for power can be supplied with power by noncontact power supply. As the system utilization price becomes higher, it is assumed that vehicles 3 with low need for power supply will no longer desire noncontact power supply. For this reason, by setting a suitable system utilization price in accordance with the demand for power, it is possible to suitably maintain the supply and demand balance of power while suitably supplying power by noncontact to vehicles 3 with a high need for power supply.

Further, in the present embodiment, the vehicle 3 is configured to transmit to the server 1 a request for issuance of a system utilization ticket when passing a preset checkpoint while the server 1 is further configured to transmit to the vehicle 3 originating the request for issuance of the system utilization ticket and the ground power supply apparatus 2 linked with the checkpoint through which that vehicle 3 passed the information required for noncontact power supply. More specifically, the server 1 is configured to transmit, as the information required for noncontact power supply, a first ticket to the vehicle 3 originating the request for issuance of a system utilization ticket and to transmit a second ticket corresponding to the first ticket to the ground power supply apparatus 2 linked with the checkpoint through which the vehicle 3 passes.

Due to this, it is possible to transmit to a ground power supply apparatus 2 installed in an electrified road section on which a vehicle 3 passing the checkpoint will run a second ticket corresponding to the first ticket.

If the electrified road section through which the vehicle 3 which transmitted the request for issuance of a system utilization ticket will pass is unclear, for example, it is necessary to postulate the electrified road sections which a vehicle 3 can run on in the future based on the position information of the vehicle 3 etc. and transmit a second ticket to the ground power supply apparatuses 2 set at all of the postulated electrified road sections. For this reason, it becomes necessary to transmit the second ticket to all of the ground power supply apparatuses 2 set in a wide ranged region and the communication load is liable to become excessively large. As opposed to this, according to the present embodiment, it is sufficient to transmit the second ticket to just the ground power supply apparatus 2 set at an electrified road section which the vehicle 3 passing the checkpoint will run on, so it is possible to keep the communication load from becoming excessively large.

Further, the server 1 according to the present embodiment is configured to newly confirm the intent for utilization of the noncontact power supply system 100 at the system utilization price set based on the demand for power when passage or approach to the checkpoint by the vehicle 3 has been confirmed.

That is, according to the present embodiment, it is possible to confirm the intent for system utilization from the next checkpoint and propose a newly set system utilization price to the vehicle 3 each time passage or approach to a checkpoint by a vehicle 3 is confirmed. For this reason, it is possible to periodically confirm the intent for system utilization at a system utilization price newly set in accordance with the demand for power at a timing easily understandable to the system user (at a good timing).

Further, the server 1 according to the present embodiment is configured so as to raise the system utilization price the greater the demand for power, so it is possible to suitably maintain the supply and demand balance of power. Further, it is configured so as to increase the assumed demand for power the larger the number of vehicles 3 requesting noncontact power supply, so it is possible to set the system utilization price to a suitable price corresponding to the demand for noncontact power supply.

Note that, the present embodiment, changed in view, can be interpreted as a method of noncontact power supply of a noncontact power supply system performed by a server 1 able to communicate with a vehicle 3 (mobile unit) and a ground power supply apparatus 2 configured to be able to supply power by noncontact to the vehicle 3, the method of noncontact power supply setting a system utilization price of the noncontact power supply system 100 based on demand for power, confirming an intent by the vehicle 3 for utilization of the noncontact power supply system 100 at the system utilization price, and, when intent for utilization is confirmed, enable the vehicle 3 with a confirmed intent for utilization to be supplied with power by noncontact by sending information necessary for noncontact power supply to the vehicle 3 with a confirmed intent for utilization and ground power supply apparatus 2.

### Second Embodiment

Next, a second embodiment of the present invention will be explained. The present embodiment differs from the first embodiment in the method for confirmation of the intent for utilization of the noncontact power supply system 100 by the system utilization price. Below, this point of difference will be focused on in the explanation.

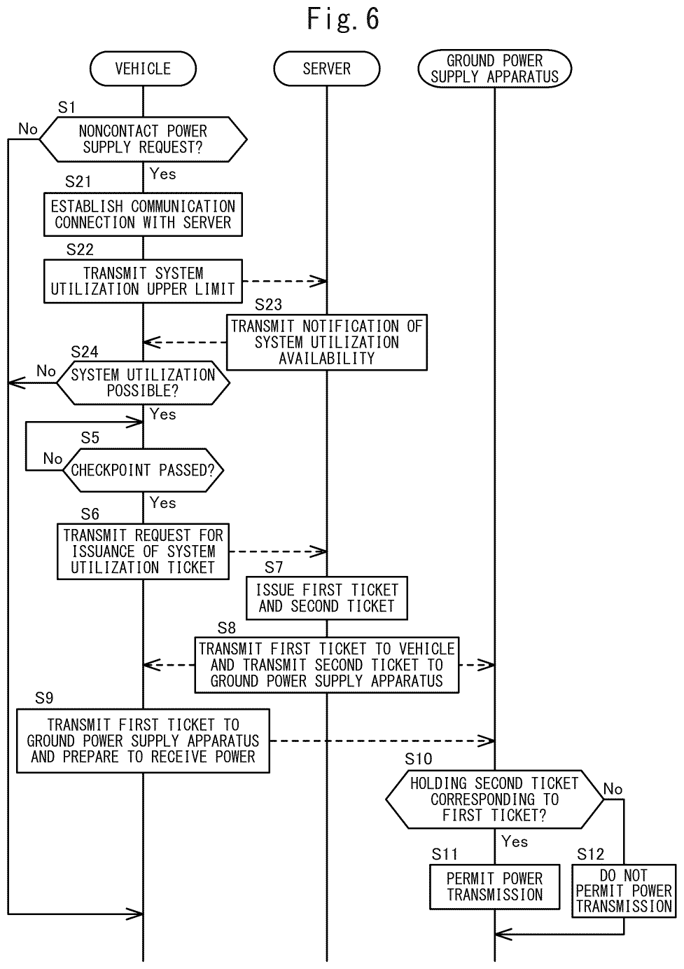

FIG. 6 is an operation sequence diagram explaining a method of supplying power by noncontact power supply according to the present embodiment. Note that, in FIG. 6, the contents of the processing steps of step S1, step S2, and step S5 to step S12 are similar to the first embodiment, so the explanations will be omitted here.

At step S21, the vehicle controller 34, for example, performs three-way handshake to establish a communication connection with the server 1.

At step S22, the vehicle controller 34 requests that the vehicle occupants set the upper limit of utilization of the noncontact power supply system 100 through the HMI device 39 (below, referred to as the “system utilization upper limit” and transmits to the server 1 a signal requesting utilization including the set system utilization upper limit. The system utilization upper limit is the upper limit value of the system utilization price when the vehicle occupants desire supply of power by the noncontact power supply.

At step S23, if confirmation is obtained that the vehicle 3 originating the signal requesting utilization has the right to utilize the noncontact power supply system 100, the server 1 compares the current system utilization price and the system utilization upper limit and transmits to the vehicle 3 originating the signal requesting utilization a notification of system utilization availability for notifying whether system utilization is possible within the range up to the system utilization upper limit.

Specifically, if the current system utilization price is less than or equal to the system utilization upper limit, the server 1 notifies, as notification of system utilization availability, the effect that system utilization is possible in the range up to the system utilization upper limit. When giving notification to the effect that system utilization is possible in the range up to the system utilization upper limit, the server 1 transmits at least an encryption key for decrypting the system utilization ticket along with the notification of system utilization availability to the vehicle 3 originating the transmission of the system utilization upper limit. In the present embodiment, when giving notification to the effect that system utilization is possible in the range up to the system utilization upper limit, the server 1 transmits the current system utilization price and encryption key together with the notification of system utilization availability to the vehicle 3 originating the transmission of the system utilization upper limit.

On the other hand, if the current system utilization price is higher than the system utilization upper limit, the server 1 gives, as notification of system utilization availability/unavailability, notification to the effect that system utilization is not possible in the range up to the system utilization upper limit. When giving notification that system utilization is not possible in the range up to the system utilization upper limit, the server 1 does not transmit the encryption key. When giving notification that system utilization is not possible in the range up to the system utilization upper limit, it is possible to transmit only that notification and possible to transmit the system utilization price together with that notification.

At step S24, if the received notification of system utilization availability is a notification to the effect that system utilization is possible within the range up to the system utilization upper limit, the vehicle controller 34 notifies the vehicle occupants to that effect through the HMI device 39 and proceeds to the processing of step S5. On the other hand, if the received notification of system utilization availability is a notification to the effect that system utilization is not possible within the range up to the system utilization upper limit, the vehicle controller 34 notifies the vehicle occupants to that effect through the HMI device 39 and ends the processing.

The server 1 according to the present embodiment explained above is configured so as to confirm the intent for utilization by the vehicle 3 of the noncontact power supply system 100 at the system utilization price based on the system utilization price and the system utilization upper limit received from the vehicle 3. Specifically, the server 1 is configured to judge that there is an intent for utilization by the vehicle 3 of the noncontact power supply system 100 at the system utilization price if the system utilization price is less than or equal to the system utilization upper limit.

Due to this, so long as the system utilization price determined based on the demand for power is less than or equal to the system utilization upper limit, even if the system utilization price fluctuates, it is possible to continue to supply power by noncontact power supply. For this reason, an effect similar to the first embodiment can be obtained and, further, the convenience at the time of system utilization can be improved.

Above, embodiments of the present invention were explained, but the above embodiments just show some of the examples of application of the present invention and are not intended to limit the technical scope of the present invention to the specific constitutions of the above embodiments.

For example, in the above-mentioned embodiments, if the vehicle 3 is for example an ambulance or other emergency vehicle, it is possible to provide permission of system use without confirming intent for system utilization and enable the emergency vehicle to always be supplied with power by noncontact.

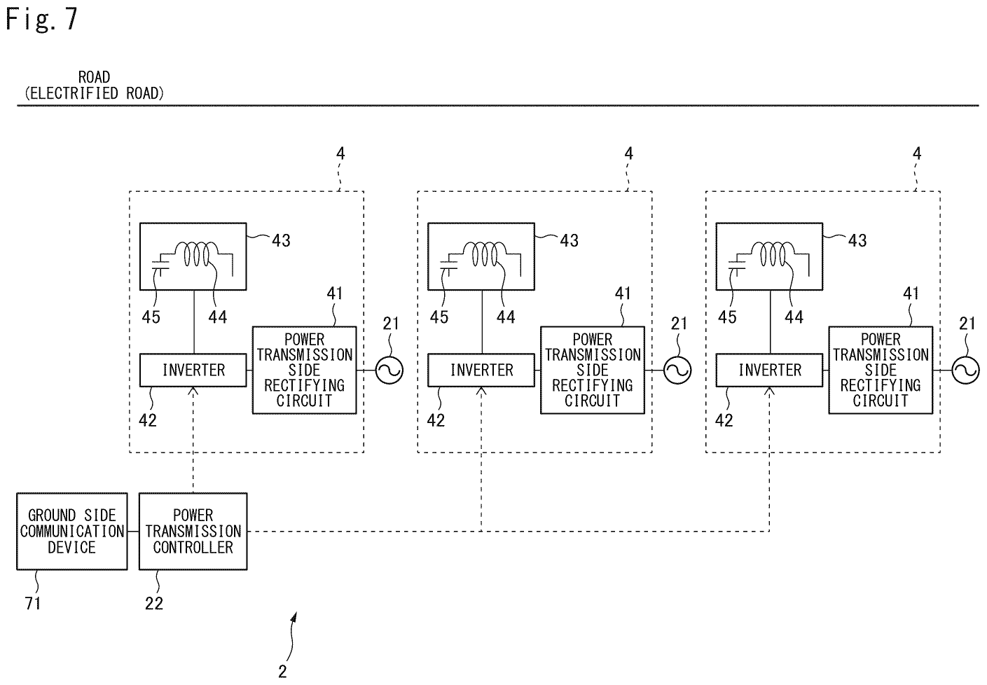

Further, for example, in the above-mentioned embodiments, as shown in FIG. 7, the ground power supply apparatus 2 may be provided with, for example, a plurality of power transmission devices 4 controlled by a single power transmission controller 22.

Further, in the above-mentioned embodiments, if the system users are not decreased even if making the system utilization price expensive corresponding to the demand for power and the supply of power is liable to become insufficient for the demand for power, it is also possible to select the vehicles to be given permission of system utilization from among the vehicles 3 with confirmed intent for system utilization by some sort of technique.

As one such technique, for example, the technique of determining priority in accordance with a level of emergency need for system utilization etc. and assigning permission of system use to vehicles 3 with high priority may be mentioned. The emergency need for system utilization may be judged, for example, higher the lower the battery state of charge of a vehicle 3, may be judged based on the type of the vehicle (private vehicle, official vehicle, commercial vehicle, etc.), or may be judged from the scheduled running route of a vehicle 3. If judged from the future running route of a vehicle 3, for example, the more a vehicle has to run on a usual road away from an electrified road or otherwise the faster the opportunity for noncontact power supply will be lost in a vehicle, the higher the emergency need can be judged. Further, as another technique, for example, the method of randomly selecting a vehicle to be given permission of system use from among the vehicles 3 with confirmed intent for system utilization may be mentioned.

Further, in the above-mentioned embodiments, in judging demand for power, if a vehicle 3 with a confirmed intent for system utilization of the noncontact power supply system 100 can no longer receive power due to some sort of reason, for example, the battery state of charge exceeding a predetermined state of charge, it may be judged that the substantive demand for electric power has fallen. Further, the result of judgment may be reflected in the system utilization price and the system utilization price may be lowered.

Further, the above first embodiment first proposed a system utilization price set based on the demand for power to a vehicle 3 which transmitted a signal requesting utilization and confirmed the intent for system utilization.

However, the invention is not limited to this. It is also possible to first propose a preset system utilization price more expensive than usual (initial set price) to a vehicle 3 which transmitted a signal requesting utilization and confirm the intent for system utilization, then, if the vehicle 3 turns down system utilization at the initial set price, if the number of other vehicles desiring system utilization at the initial set price is low and actual demand for power is low, repurpose to the vehicle 3 a system utilization price lower than the initial set price and reconfirm the intent for system utilization. In this way, it is also possible to lower the system utilization price from the preset initial set price in accordance with the demand for power.

Due to this, if supplying power by noncontact to a vehicle 3 with an assumed high emergency need for noncontact power supply desiring system utilization by an expensive initial set price while there is still extra leeway in power supply, it is possible to use it for noncontact power supply without wasting that extra leeway.

1. A noncontact power supply system comprising:
a mobile unit;
a ground power supply apparatus configured to be able to supply power by noncontact to the mobile unit; and
a server configured to be able to communicate with the mobile unit and the ground power supply apparatus respectively, wherein
the server is configured to:
set a system utilization price of the noncontact power supply system based on the demand for power; and,
when an intent by the mobile unit for utilization of the noncontact power supply system at the system utilization price is confirmed, enable the mobile unit with a confirmed intent for utilization to be supplied with power by noncontact by sending information necessary for noncontact power supply to the mobile unit with a confirmed intent for utilization and ground power supply apparatus.

2. The noncontact power supply system according to claim 1, wherein
the server is configured to notify the system utilization price to the mobile unit and receive a reply based on the notification from the mobile unit to thereby confirm the intent of the mobile unit for utilization of the noncontact power supply system at the system utilization price.

3. The noncontact power supply system according to claim 2, wherein
the reply is a request for issuance of a virtual ticket for utilization of the noncontact power supply system.

4. The noncontact power supply system according to claim 3, wherein
the mobile unit is configured to send a request for issuance of the ticket to the server when passing a preset checkpoint or when approaching the checkpoint and
the server is configured to send information required for noncontact power supply to the mobile unit originating the request for issuance of the ticket and a ground power supply apparatus associated with the checkpoint which the mobile unit passes or approaches.

5. The noncontact power supply system according to claim 4, wherein
the server is configured to send, as the information required for noncontact power supply, a first ticket to the mobile unit originating the request for issuance of the ticket and to send a second ticket corresponding to the first ticket to the ground power supply apparatus associated with the checkpoint which the mobile unit passes.

6. The noncontact power supply system according to claim 4, wherein
the server is configured to newly confirm the intent of utilization of the noncontact power supply system at the system utilization price set based on the demand for power when having confirmed passage or approach to the checkpoint by the mobile unit.

7. The noncontact power supply system according to claim 1, wherein
the server is configured to confirm the intent by the mobile unit for utilization of the noncontact power supply system at the system utilization price based on the system utilization price and an upper limit of system utilization received from the mobile unit.

8. The noncontact power supply system according to claim 7, wherein
the server is configured so that when the system utilization price is the upper limit of system utilization, it judges that there is the intent by the mobile unit for utilization of the noncontact power supply system at the system utilization price.

9. The noncontact power supply system according to claim 1, wherein
the server is configured to raise the system utilization price the greater the demand for power.

10. The noncontact power supply system according to claim 9, wherein
the server is configured to increase the assumed demand for power the greater the number of mobile units requesting noncontact power supply.

11. A server comprising:
a processing part; and
a communication part configured so as to communicate with a mobile unit and a ground power supply apparatus configured to be able to supply power by noncontact to the mobile unit, wherein
the processing part is configured to:
set a system utilization price of the noncontact power supply system supplying power by noncontact to the mobile unit based on demand for power; and,
when an intent by the mobile unit for utilization of the noncontact power supply system at the system utilization price is confirmed, enable the mobile unit with a confirmed intent for utilization to be supplied with power by noncontact by sending information necessary for noncontact power supply to the mobile unit with a confirmed intent for utilization and ground power supply apparatus.

12. A method of noncontact power supply of a noncontact power supply system performed by a server able to communicate with a mobile unit and a ground power supply apparatus configured to be able to supply power by noncontact to the mobile unit, wherein
the method of noncontact power supply includes:
setting a system utilization price of the noncontact power supply system based on demand for power;
confirming an intent by the mobile unit for utilization of the noncontact power supply system at the system utilization price; and,
sending information necessary for noncontact power supply to the mobile unit with a confirmed intent for utilization and ground power supply apparatus so as to enable the mobile unit with a confirmed intent for utilization to be supplied with power by noncontact when intent for utilization is confirmed.
